(19) United States
(12) Patent Application Publication
(10) Pub. No.: US 2019/0003879 A1
(43) Pub. Date: Jan. 3, 2019

(54) IMPROVED OPTICAL FIBER SENSING SYSTEM

(71) Applicant: HAWK MEASUREMENT SYSTEMS PTY. LTD., Nunawading, Victoria (AU)

(72) Inventors: Hong Chung Bao, Clayton (AU); Colin Prohasky, Warranwood (AU)

(21) Appl. No.: 16/060,413

(22) PCT Filed: Dec. 1, 2016
(86) PCT No.: PCT/AU2016/051184

§ 371 Date: Jun. 7, 2018

(30) Foreign Application Priority Data
Dec. 8, 2015 (AU) 2015905077

(51) Int. Cl. G01H 9/00; G02B 6/02; G01V 1/00

(52) U.S. Cl. CPC G01H 9/004; G02B 6/02; G01D 5/34; G01V 2210/142; G01V 1/001

(57) ABSTRACT

An optical fiber sensing system is disclosed for sensing presence of an acoustic event such as acoustic waves or vibration along a path. The sensing system includes means for producing a plurality of pulses of coherent light. The system includes a first optical sensing fiber for receiving at least a first portion of the pulses of coherent light and adapted to be positioned along the path, the first optical sensing fiber producing first backscattered light in response to receiving said pulses of coherent light. The system includes a second optical sensing fiber for receiving at least a second portion of said pulses of coherent light pulses and adapted to be positioned along said path, the second optical sensing fiber producing second backscattered light in response to receiving said pulses of coherent light. The system includes first receiving means arranged to receive the first backscattered light for producing a first optical signal in response to a perturbation in the first backscattered light, and second receiving means arranged to receive the second backscattered light for producing a second optical signal in response to a perturbation in the second backscattered light. The system further includes means for generating a resultant signal in response to the first and/or the second optical signal wherein the resultant signal is indicative of presence of the acoustic event along the path. A method of sensing presence of an acoustic event such as acoustic waves or vibration along a path is also disclosed.

### FIELD OF THE INVENTION

The present invention relates to the field of optical fiber sensors and in particular relates to a multichannel optical fiber sensing system having improved sensitivity.

### BACKGROUND OF THE INVENTION

Each point of an optical fiber may act as a sensor to provide a distributed sensor along the length of the optical fiber. The distributed optical fiber sensor may be associated with a path such as a defined perimeter which is to be monitored for intrusion or the like. Distributed optical fiber sensors may have multiple applications in the field, including detecting an acoustic event such as acoustic waves or vibration associated with perimeter intrusion, flow and/or leaks in pipelines, flow and seismic activity in boreholes, traffic in roads, breaks in railways, etc.

Distributed optical fiber sensors typically use a coherent light source such as a laser light to illuminate an optical fiber and to collect and process backscattered or reflected light from the optical fiber with a view to determining presence of acoustic waves or vibrations in the vicinity of the optical fiber. The process of sending and receiving laser light in this way is known as Coherent Optical Time-Domain Reflectometry (COTDR).

A typical prior art distributed optical fiber sensing system is shown in FIG. 1, wherein a laser light from laser 10 is coupled to optical isolator 11 and is split into two parts 13, 14 by optical coupler 12. One split part 13 is modulated into pulsed light via optical modulator 15 and is launched through optical coupler 16 to optical sensing fiber 17 having non-reflecting end 18. Backward Rayleigh scattered light is collected by optical sensing fiber 17 and is sent back via optical coupler 16 and another optical fiber 19 to combine with split part 14 of light from laser 10 as local oscillator. The combined light is coherently added up and detected by a detector comprising coupler 20, photodetectors 21, 22 and differential amplifier 23. The output of differential amplifier 23 is a signal 24 indicative of an acoustic event such as acoustic waves or vibration that may arise from an intrusion into a monitored perimeter.

One problem associated with prior art distributed optical fiber sensors is that signal fading may take place at one or more points of the distributed sensor due to destructive interference of the backward Rayleigh scattered light. Therefore, the distributed sensor may have significantly reduced sensitivity to acoustic events such as acoustic waves or vibration at least at the or each signal fading point.

Another problem associated with prior art distributed optical fiber sensors is that peak power and signal to noise ratio of optical pulses (also known as extinction ratio) generated by the optical modulator may be degraded and may not be sufficient to reliably detect acoustic events over path distances more than about 20 km. If path distance is too long, accumulated Rayleigh scattering and reflections in the optical fiber may not be ignored and may contribute as noise and degrade overall signal to noise ratio of the distributed optical fiber sensor.

The present invention may alleviate the disadvantages of the prior art or at least may provide the consumer with a choice.

A reference herein to a patent document or other matter which is given as prior art is not to be taken as an admission that that document or matter was known or that the information it contains was part of the common general knowledge in Australia or elsewhere as at the priority date of any of the disclosure or claims herein. Such discussion of prior art in this specification is included to explain the context of the present invention in terms of the inventor's knowledge and experience.

Throughout the description and claims of this specification the words “comprise” or “include” and variations of those words, such as “comprises”, “includes” and “comprising” or “including, are not intended to exclude other additives, components, integers or steps.

### SUMMARY OF THE INVENTION

According to one aspect of the present invention there is provided an optical fiber sensing system for sensing presence of an acoustic event such as acoustic waves or vibration along a path, said sensing system comprising: means for producing a plurality of pulses of coherent light; a first optical sensing fiber for receiving at least a first portion of said pulses of coherent light and adapted to be positioned along said path, said first optical sensing fiber producing first backscattered light in response to receiving said pulses of coherent light; a second optical sensing fiber for receiving at least a second portion of said pulses of coherent light pulses and adapted to be positioned along said path, said second optical sensing fiber producing second backscattered light in response to receiving said pulses of coherent light; first receiving means arranged to receive said first backscattered light for producing a first optical signal in response to a first perturbation in said first backscattered light; second receiving means arranged to receive said second backscattered light for producing a second optical signal in response to a second perturbation in said second backscattered light; and means for generating a resultant signal in response to said first and/or said second optical signal wherein said resultant signal is indicative of presence of said acoustic event along said path.

The apparatus may include a third (and subsequent) optical sensing fiber for receiving at least a third (and subsequent) portion of the pulses of coherent light and adapted to be positioned along the path, the third optical sensing fiber producing third (and subsequent) backscattered light in response to receiving the pulses of coherent light, and third (and subsequent) receiving means arranged to receive the third (and subsequent) backscattered light for producing a third (and subsequent) optical signal in response to a third (and subsequent) perturbation in the third (and subsequent) backscattered light, and wherein the resultant signal is generated in response to the first and/or the second and/or the third (and subsequent) optical signal.

The means for producing pulses of coherent light may include a laser for producing coherent light and means coupled to the laser for producing the pulses of coherent light.

The pulses of coherent light may include a spectral bandwidth of coherent light less than several kHz, wherein the latter is the bandwidth of the coherent light. The means for producing pulses of coherent light may include an optical switch. Alternatively the means for producing pulses of coherent light may include an optical intensity modulator. Preferably, the means for producing pulses of coherent light includes at least two optical intensity modulators or optical switches operating in tandem to reduce noise and/or to reduce incidence of signal fading. The means for producing pulses of coherent light may include at least one optical amplifier. Each optical sensing fiber may be terminated via a non-reflecting end.

The apparatus may include means for optically coupling the optical sensing fibers and the receiving means. Each optical coupling means may include an optical circulator or optical splitter. Alternatively, each optical coupling means may include an optical fiber coupler.

Each receiving means may include a respective photodetector coupled to a respective optical sensing fiber for receiving the backscattered light and for producing an electrical signal indicative of optical power of the backscattered light.

Each receiving means may include a respective signal amplifier coupled to a respective photodetector for amplifying each respective electrical signal. Each electrical signal may be indicative of an acoustic event at a distance Lᵢ along the path computable by:

$${L}_{i} = \frac{cTi}{2 {n}_{g}}$$

wherein Ti is the time delay associated with the first and/or second perturbation, c is the free-space velocity of light, and n_{g} is the group refractive index of each optical sensing fiber.

The means for generating a resultant signal may include a control unit such as a digital processor for processing the signals. The control unit or processor may include an algorithm for comparing the signals and for generating the resultant signal in response to the comparison. In one form the resultant signal may comprise an instantaneous signal level based on whichever of the compared signals is greater.

One advantage of an optical fiber sensing system that contains two (or more) optical sensing fibers that are colocated along the same monitored path is that the second sensing fiber may reduce or substantially eliminate the effect of signal fading that may occur due to destructive interference on the first sensing fiber.

In particular, if an acoustic event takes place at one position (Lᵢ) along the monitored path, it will give rise to perturbations in the backscattered light associated with each optical sensing fiber and corresponding to the one position (Lᵢ), assuming that the or each optical sensing fiber is substantially colocated with the monitored path.

If signal fading does occur on the first optical sensing fiber corresponding to the one position (Lᵢ) along the monitored path, it may mask receipt of the first signal that is produced in response to the first perturbation. However, since signal fading is unlikely to occur on the second and/or subsequent optical sensing fibers corresponding to same position (Lᵢ) on the monitored path, receipt of the second and/or subsequent signal(s), that is/are produced in response to the second and/or subsequent perturbation may not be impaired.

The reason for this is that the probability of signal fading occurring at the same time in the same position on each colocated sensing fiber may be very small because signal fading due to destructive interference is generally unique to optical properties of a specific optical fiber.

If signal fading does occur on one sensing fiber which corresponds to position Lᵢ along the monitored path, the signal may be used from one of the other sensing fibers to detect presence of an acoustic event that occurs at the position Lᵢ along the monitored path.

In practice, an optical fiber sensing system containing two (or more) optical sensing fibers (or channels) may provide good performance that is substantially resistant to signal fading. However, the cost of a sensing system with multiple sensing fibers may be significant when compared with the cost of a basic system. In particular, a system may be implemented with three or more channels of sensing fibers at significant cost and complexity but may yield only marginal improvement in performance over a more modest system with say only two channels. Thus, depending on the application, a trade off in cost versus performance and/or other factors such as compromises in pulse power need to be considered on a case by case basis.

According to a further aspect of the present invention there is provided a method of sensing presence of an acoustic event such as acoustic waves or vibration along a path by means of at least first and second optical sensing fibers adapted to be positioned along said path, said method comprising the steps of: producing a plurality of pulses of coherent light; injecting at least a first portion of said pulses of coherent light into said first optical sensing fiber and producing first backscattered light in response to injecting said first portion of light; injecting at least a second portion of said pulses of coherent light into said second optical sensing fibre and producing second backscattered light in response to injecting said second portion of light; receiving said first backscattered light and producing a first optical signal in response to a first perturbation in said first backscattered light; receiving said second backscattered light and producing a second optical signal in response to a second perturbation in said second backscattered light; and generating a resultant signal in response to said first and/or said second optical signal indicative of presence of said acoustic event along said path.

### DESCRIPTION OF THE DRAWINGS

FIG. 1 shows a prior art optical fiber sensing system;

FIG. 2 shows a dual channel optical fiber sensing system according to one embodiment of the present invention;

FIG. 3 shows a dual channel optical fiber sensing system according to another embodiment of the present invention;

FIG. 4 shows a dual channel optical fiber sensing system according to another embodiment of the present invention;

FIG. 5 shows a dual channel optical fiber sensing system according to another embodiment of the present invention;

FIG. 6 shows a three (or more) channel optical fiber sensing system according to one embodiment of the present invention;

FIG. 7 shows a three (or more) channel optical fiber sensing system according to another embodiment of the present invention;

FIG. 8 shows a three (or more) channel optical fiber sensing system according to another embodiment of the present invention; and

FIG. 9 shows a three (or more) channel optical fiber sensing system according to another embodiment of the present invention.

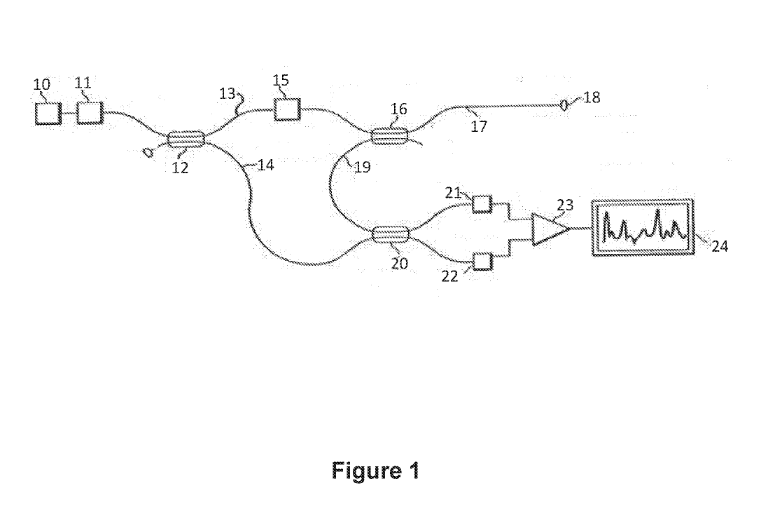

### DESCRIPTION OF A PREFERRED EMBODIMENT

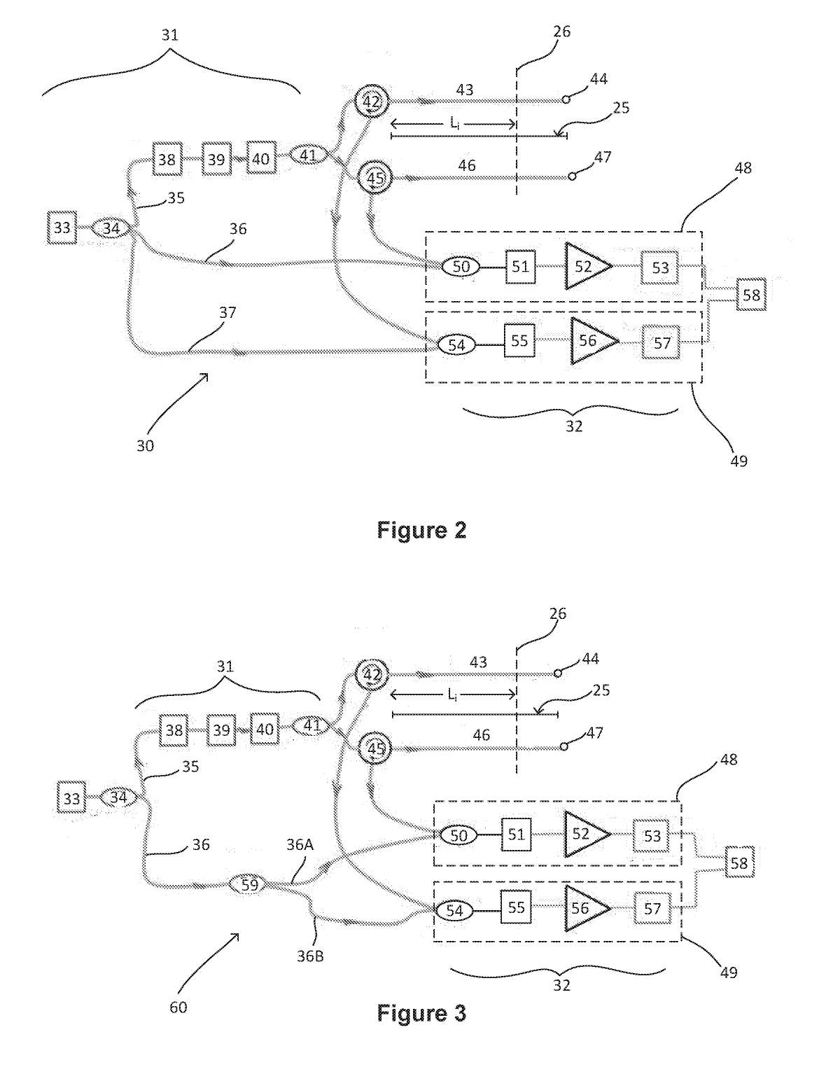

FIG. 2 shows a dual channel optical fiber sensing system 30 for sensing presence of acoustic waves or vibration along a path 25. Sensing system 30 makes use of Coherent Optical Time-Domain Reflectometry and includes transmitter 31 and receiver 32. Transmitter 31 includes continuous wave (CW) laser light from narrow linewidth laser 33. Light from laser 33 is split into three parts 35, 36, 37 via optical coupler 34.

One part 35 is externally modulated into pulsed light via optical intensity modulator 38. Optical modulator 38 may comprise an optical switch. The optical switch may include an Electro Optic Modulator (EOM), a Semiconductor Optical Amplifier (SOA) used as a modulator or an Acousto-Optical Modulator (AOM). The on/off extinction ratio of optical pulses generated by an optical switch is typically about 20-50 dB. Because peak power of optical pulses generated by the optical switch may not be sufficient over long path distances, optical pulses created by optical modulator 38 are amplified via optical amplifier 39 to boost power of the optical pulses. Optical amplifier 39 may comprise an Erbium-Doped Fiber Amplifier (EDFA), SOA or another device having comparable functionality.

However, Amplified Spontaneous Emission (ASE) noise from an EDFA or other optical amplifier may further degrade the on/off extinction ratio of the optical pulse from modulator 38. In order to improve the extinction ratio of the optical pulses, a second optical intensity modulator 40 is added in tandem to modulate the light from laser 33. Second optical intensity modulator 40 may comprise an AOM. An AOM may be driven via an RF amplifier allowing the light level to be modulated by an RF signal wherein the frequency of the laser light is also varied in accordance with the RF signal. The AOM may pass or block light with an on/off extinction ratio of about 50 dB.

Second optical modulator 40 is synchronized with optical modulator 38 so that optical intensity of modulators 38, 40 is at a minimum/maximum at substantially the same time. Second optical modulator 40 operating in tandem with optical modulator 38 may boost the extinction ratio of the optical pulses to over 70 dB and/or may reduce ASE noise from optical amplifier 39. Second optical modulator 40 may also substantially eliminate accumulated noise from the non-ideal “zero” part of the optical pulses. As noted above, optical modulator 38 may perform the function of an optical switch and optical modulator 40 may perform the function of an AOM, optical switch, SOA or EOM. However, in some embodiments the functions of modulators 38, 40 may be reversed if the modulators are adequately rated.

Heterodyne modulation may be adopted to eliminate signal fading due to phase. Heterodyne modulation may shift the local oscillator light to a frequency different from that of the optical pulses or may shift the optical pulses to a frequency different from that of the local oscillator light. In that case, optical modulator 38, 40 or both may be used to not only generate optical pulses but to also shift the optical frequency of the pulses to be different from the CW laser light acting as local oscillator.

Sensing system 30 may be configured to operate as a dual channel or a single channel fiber optics sensor. When dual channel operation is required the optical pulses are split by optical coupler 41 and launched via respective optical circulators or couplers 42, 45 into separate optical sensing fibers 43, 46 positioned along path 25.

Optical sensing fibers 43, 46 include non-reflecting ends 44, 47 respectively, however a portion of light from fibers 43, 46 is scattered by a phenomenon called Rayleigh backscattering. The backscattered light is collected by sensing fibers 43, 46 and is sent back via optical circulators or couplers 42, 45 to be coherently combined with split parts 36, 37 of light from laser 33 acting as local oscillator.

If single channel operation is required, optical pulses may be launched into a single sensing fiber 43 (or 46) without splitting. Backward Rayleigh scattered light may be collected by sensing fiber 43 (or 46) and coherently combined with light from laser 33 acting as local oscillator. However, the advantages of an optical fiber sensing system that contains multiple optical sensing fibers along the same monitored path will not be obtained.

When monitored path 25 such as a defined perimeter which is to be secured against intrusion is breached, acoustic waves or vibration are produced at the location (26) of the breach. The acoustic waves or vibrations produce localized perturbations in the effective refractive index of sensing fibers 43, 46. This gives rise to a change in the backward Rayleigh scattered light collected by sensing fibers 43, 46. The change in the backward Rayleigh scattered light may be detected to indicate the presence of acoustic waves or vibration at location 26 which is at distance Lᵢ along monitored path 25 whenever a change or perturbation in the refractive index occurs.

Backward Rayleigh scattered light may be detected via receiver 32 as described below. Receiver 32 includes receiver channels 48, 49 for respective sensing fibers 43, 46. Receiver channel 48 includes optical coupler 50, photodetector 51, signal amplifier 52 and signal demodulator 53. Receiver channel 49 includes optical coupler 54, photodetector 55, signal amplifier 56 and signal demodulator 57.

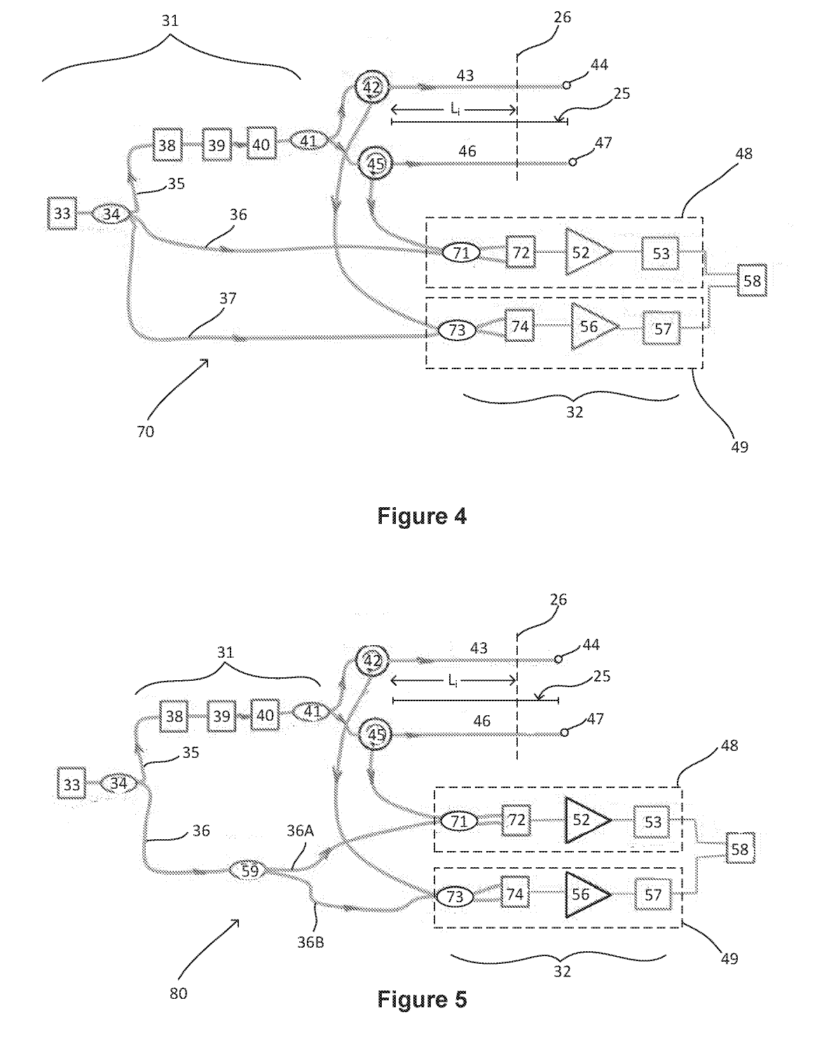

Each photodetector 51, 55 may comprise an unbalanced (refer FIGS. 2 and 3) or balanced (refer FIGS. 4 and 5) photodetector. Photodetectors 51, 55 produce electrical signals that reflect the patterns of light that are produced from interference in optical couplers 50, 54 and are coherently added up. The photodetected electrical signals are amplified via signal amplifiers 52, 56 and pass to signal demodulators 53, 57.

Signal demodulators 53, 57 perform coherent signal recovery and remove the carrier frequency component. In heterodyne modulation, the optical frequency of Rayleigh scattering is different from that of the local oscillator; hence the electrical signal produced by photodetectors 51, 55 has a carrier frequency equal to the frequency difference between Rayleigh scattering and that of the local oscillator. To remove this carrier frequency, the signals produced by photodetectors 51, 55 may be mixed with an IF (intermediate frequency) sinusoidal signal having a frequency equal to that of the carrier, and a low pass filter is used to remove the carrier from the output of the mixer.

The demodulated electrical signals may then be sampled and sent to control unit 58 for further processing. The further processing may include comparing instantaneous output levels from signal demodulators 53, 57 and providing an output which comprises the greater of the output of signal demodulator 53 or 57. The output of control unit 58 may be indicative of an acoustic event such as an intrusion or other disturbance along monitored path 25.

In summary, optical fiber sensing system 30 functions by allowing interference to occur between backscattered light caused by Rayleigh backscattering from sensing fibers 43, 46 and the light produced by the light source from laser 33 and optical coupler 34, at optical fiber couplers 50, 54 via paths 36, 37. The interference effect is detected by photodetectors 51 and 55 and processed by signal amplifiers 52, 56 and demodulators 53, 57. A localized change in the effective refractive index or polarization of backscattered light associated with sensing fibers 43, 46 causes a change in the interference pattern of the light, which is detectable by receiver channels 48, 49. Such change may be interpreted to indicate occurrence of one or more acoustic events such as an intrusion or other disturbance, the approximate position of which may be computed as described above.

A dual channel fiber sensing system as described above has an advantage in that it may reduce or substantially eliminate the effect of signal fading due to destructive interference that may take place along colocated sensing fibers 43, 46. Because signals from receiver channels 48, 49 may be decoded independently, and if signal fading does occur at one position (Lᵢ) on sensing fiber 43 (or 46), the signal may be used from the other sensing fiber 46 (or 43) to detect presence of an acoustic event because the probability of fading due to destructive interference occurring at the same time in the same position 26 on both colocated sensing fibers 43, 45 is very small.

Thus, use of colocated sensing Fibers 43, 46 and dual channel decoding may substantially eliminate the effect of signal fading due to destructive interference along sensing fibers 43, 46.

FIG. 3 shows a dual channel optical fiber sensing system 60 that is constructed and operates in similar fashion to sensing system 30 in FIG. 2 as described above and wherein like labels show like parts. However in FIG. 3, light from laser 33 is initially split into two parts 35, 36 via optical coupler 34. Split part 36 is further split into two parts 36A, 36B via optical coupler 59. In FIG. 3, parts 36A, 36B perform roles that are similar to parts 36, 37 in the embodiment of FIG. 2.

FIG. 4 shows a dual channel optical fiber sensing system 70 that is constructed and operates in similar fashion to sensing system 30 in FIG. 2 as described above and wherein like labels show like parts. However in FIG. 4, unbalanced photodetectors 51, 55 are replaced with balanced photodetectors 72, 74 and optical couplers 50, 54 are replaced with optical couplers 71, 73.

FIG. 5 shows a dual channel optical fiber sensing system 80 that is constructed and operates in similar fashion to sensing system 60 in FIG. 3 as described above and wherein like labels show like parts. However in FIG. 5, unbalanced photodetectors 51, 55 are replaced with balanced photodetectors 72, 74 and optical couplers 50, 54 are replaced with optical couplers 71, 73.

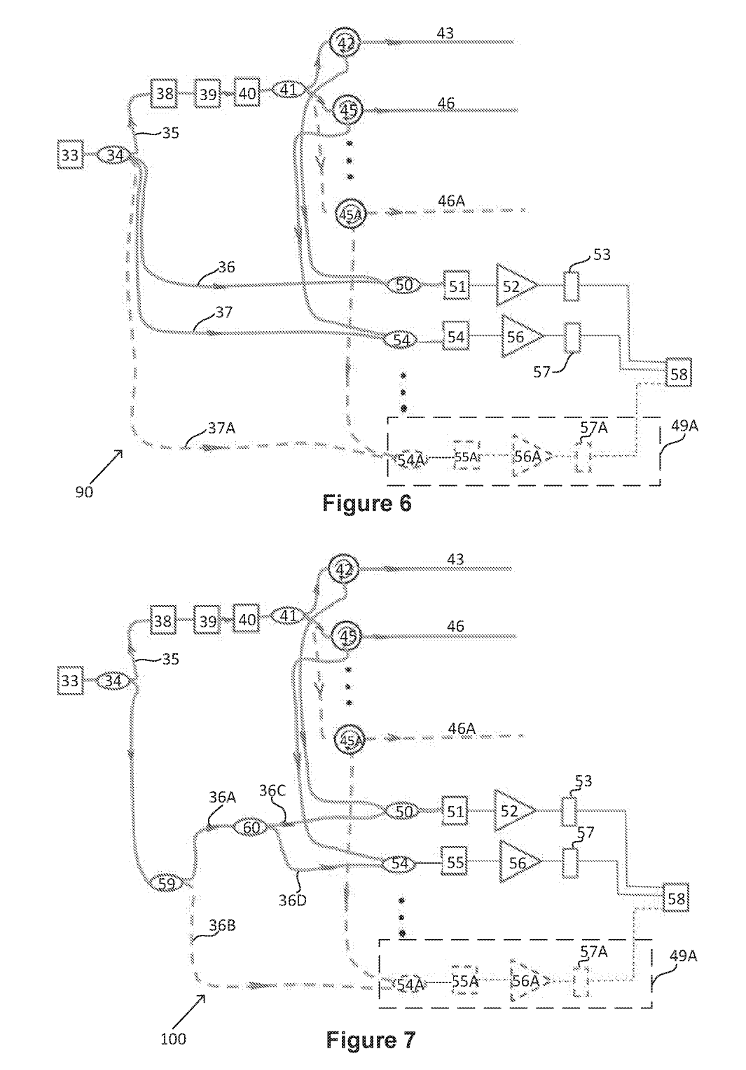

FIG. 6 shows a three (or more) channel fiber sensing system 90 that is constructed and operates in similar fashion to fiber sensing system 30 in FIG. 2 as described above and wherein like labels show like parts. However, in FIG. 6, light from laser 33 is split into an additional path 37A via coupler 34, and optical pulses split by optical coupler 41 are launched via circulator 45A into additional optical sensing fiber 46A. Receiver 32 includes additional receiver channel 49A for sensing fiber 46A. Receiver channel 49A includes optical coupler 54A, photodetector 55A, signal amplifier 56A and signal demodulator 57A. The backscattered light collected from sensing fiber 46A is sent back via optical circulator 45A to be combined with split part 37A via optical coupler 54A while the output of demodulator 57A is sent to control unit 58 for further processing as described above.

FIG. 7 shows a three (or more) channel fiber sensing system 100 that is constructed and operates in similar fashion to sensing system 90 in FIG. 6 as described above and wherein like labels show like parts. However, in FIG. 7, light from laser 33 is initially split into parts 36A, 36B via optical coupler 59. Split part 36A is further split into two parts 36C, 36D via optical coupler 60. In FIG. 7, parts 36B, 36C, 36D perform roles that are similar to parts 36, 37, 37A in FIG. 6.

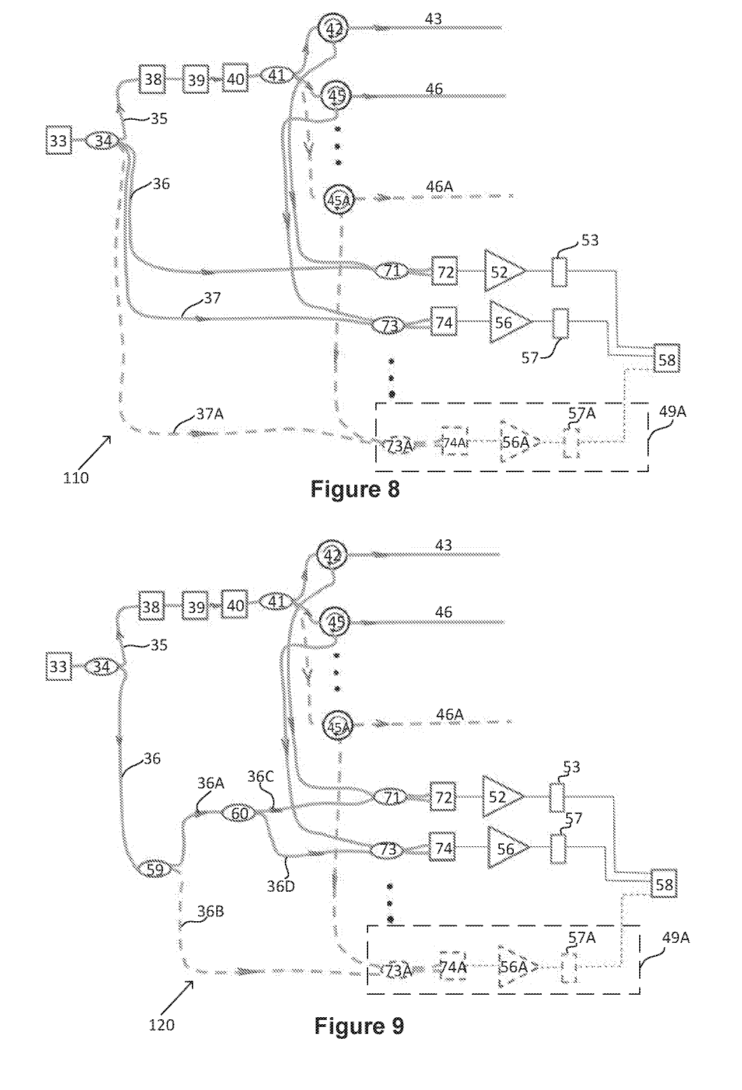

FIG. 8 shows a three (or more) channel optical fiber sensing system 110 that is constructed and operates in similar fashion to sensing system 90 in FIG. 6 as described above and wherein like labels show like parts. However, in FIG. 8, unbalanced photodetectors 51, 55, 55A are replaced with balanced photodetectors 72, 74, 74A and optical couplers 50, 54, 54A are replaced with optical couplers 71, 73, 73A.

FIG. 9 shows a three (or more) channel optical fiber sensing system 120 that is constructed and operates in similar fashion to sensing system 100 in FIG. 7 as described above and wherein like labels show like parts. However, in FIG. 9, unbalanced photodetectors 51, 55, 55A are replaced with balanced photodetectors 72, 74, 74A and optical couplers 50, 54, 54A are replaced with optical couplers 71, 73, 73A.

Sensing system 30, 60, 70, 80, 90, 100, 110 or 120 of the present invention may be constructed from components that are readily commercially available. The components that may be used to construct an optical fiber sensing system according to the present invention are well known to persons skilled in the art. In one form, the components may implement specifically a light wavelength of 1550 nm although it is to be appreciated that the apparatus is not limited to operation at this particular wavelength. It may also be noted that a coherent light beam from a laser may be converted into coherent light pulses by pulsed optical intensity modulators shown in the described embodiments, or by any device that may effectively and alternately allow the light to pass and not pass in a controlled manner. One such device may include an optical switch, SOA, EOM or AOM which may include an integrated optic device or an optical amplifier. With current laser technology, such coherent light pulses may not be achieved by turning the laser on and off, since the frequency of the laser output may change due to thermally induced “chirping” effects. Any narrow line source that is capable of emitting coherent pulses of light may be incorporated into the optical fiber sensing system of the present invention.

Finally, it is to be understood that various alterations, modifications and/or additions may be introduced into the constructions and arrangements of parts previously described without departing from the spirit or ambit of the invention.

1. An optical fiber sensing system for sensing presence of an acoustic event such as acoustic waves or vibration along a path, said sensing system comprising:
at least one of an optical switch or an optical intensity modulator for producing a plurality of pulses of coherent light;
a first optical sensing fiber for receiving at least a first portion of said pulses of coherent light and adapted to be positioned along said path, said first optical sensing fiber producing first backscattered light in response to receiving said pulses of coherent light;
a second optical sensing fiber for receiving at least a second portion of said pulses of coherent light pulses and adapted to be positioned along said path, said second optical sensing fiber producing second backscattered light in response to receiving said pulses of coherent light;
a first receiver arranged to receive said first backscattered light for producing a first optical signal in response to a perturbation in said first backscattered light;
a second receiver arranged to receive said second backscattered light for producing a second optical signal in response to a perturbation in said second backscattered light; and
a control unit configured to generate a resultant signal in response to said first and/or said second optical signal wherein said resultant signal is indicative of presence of said acoustic event along said path.

2. An apparatus according to claim 1, including a third optical sensing fiber for receiving at least a third portion of said pulses of coherent light and adapted to be positioned along said path, said third optical sensing fiber producing third backscattered light in response to receiving said pulses of coherent light, and third receiver arranged to receive said third backscattered light for producing a third optical signal in response to a perturbation in said third backscattered light, and wherein said resultant signal is generated in response to said first and/or said second and/or said third optical signal.

3. Apparatus, according to claim 1, wherein said optical switch or optical intensity modulator includes a laser for producing pulses of coherent light.

4. Apparatus according to claim 2, wherein said pulses of coherent light include a spectral bandwidth less than several kHz wherein the latter is the bandwidth of each pulse of coherent light.

5. (canceled)

6. (canceled)

7. Apparatus according to claim 1, wherein said optical intensity modulator includes at least two optical intensity modulators operating in tandem to reduce noise.

8. Apparatus according to claim 1, wherein said optical intensity modulator includes at least one optical amplifier.

9. Apparatus according to claim 1, wherein each optical sensing fiber is terminated via a non-reflecting end.

10. Apparatus according to claim 1, including one or more couplers for optically coupling said optical sensing fibers and each of said first and second receivers.

11. Apparatus according to claim 10, wherein each coupler includes at least one of an optical circulator, an optical splitter or an optical fiber coupler.

12.-13. (canceled)

14. Apparatus according to claim 1, wherein each of the first and second receivers includes a respective photodetector coupled to a respective optical sensing fiber for receiving said backscattered light and for producing an electrical signal indicative of optical power of said backscattered light.

15.-17. (canceled)

18. A method of sensing presence of an acoustic event such as acoustic waves or vibration along a path by means of first and second optical sensing fibers adapted to be positioned along said path, said method comprising the steps of:
producing a plurality of pulses of coherent light;
injecting at least a first portion of said pulses of coherent light into said first optical sensing fiber and producing first backscattered light in response to injecting said first portion of light;
injecting at least a second portion of said pulses of coherent light into said second optical sensing fibre and producing second backscattered light in response to injecting said second portion of light;
receiving said first backscattered light and producing a first optical signal in response to a first perturbation in said first backscattered light;
receiving said second backscattered light and producing a second optical signal in response to a second perturbation in said second backscattered light; and
generating a resultant signal in response to said first and/or said second optical signal indicative of presence of said acoustic event along said path.

19. A method according to claim 18, wherein a third optical sensing fiber is adapted to be positioned along said path, and including the steps of:
injecting at least a third portion of said pulses of coherent light into said third optical sensing fiber and producing third backscattered light in response to injecting said third portion of light;
receiving said third backscattered light and producing a third optical signal in response to a third perturbation in said third backscattered light; and
wherein said resultant signal is generated in response to said first and/or said second and/or said third optical signal.

20. The method according to claim 18, wherein said step of producing pulses of coherent light includes the steps of:
operating a laser to produce coherent light; and
modulating said coherent light to produce said pulses of coherent light.

21. A method according to claim 18 wherein said pulses of coherent light have a spectral width less than several kHz, wherein the latter is the bandwidth of each pulse of coherent light.

22. A method according to claim 18, wherein said step of producing pulses of coherent light includes operating one of an optical switch or an optical intensity modulator.

23. (canceled)

24. A method according to claim 18, wherein said step of producing pulses of coherent light includes operating at least two optical intensity modulators in tandem to reduce noise.

25. A method according to claim 18, wherein said step of producing pulses of coherent light includes operating at least one optical amplifier.

26. A method according to claim 18, wherein each step of receiving backscattered light includes photodetecting said backscattered light and producing a respective electrical signal indicative of optical power of said backscattered light.

27. (canceled)

28. A method according to claim 26, further including providing a fiber coupler to optically couple each optical sensing fiber to a respective photodetector for producing a respective electrical signal.

29. (canceled)

30. A method according to claim 18, wherein each electrical signal is indicative of said acoustic waves or vibration at a distance Lᵢ along said path and including the step of computing said distance Lᵢ along said path by:
$${L}_{i} = \frac{cTi}{2 {n}_{g}}$$
wherein Ti is the time delay associated with each perturbation, c is the free-space velocity of light, and n_{g} is the group refractive index of each optical sensing fiber.

31.-35. (canceled)
